(19) United States
(12) Patent Application Publication
(10) Pub. No.: US 2026/0049806 A1
(43) Pub. Date: Feb. 19, 2026

(54) Tape measure with differential optical encoder

(71) Applicant: Reekon Tools Inc., Boston, MA (US)

(72) Inventors: Konstantinos Oikonomopoulos, Boston, MA (US); Colton Black, Westford, MA (US); Harrison White, Somerville, MA (US); Edgar Sutawika, Cambridge, MA (US)

(21) Appl. No.: 18/808,230

(22) Filed: Aug. 19, 2024

(51) Int. Cl. G01B 3/1094; G01B 3/00; G01B 3/1069; G01B 11/02

(52) U.S. Cl. CPC G01B 3/1094; G01B 3/006; G01B 3/1069; G01B 11/02

(57) ABSTRACT

A digital tape measure device is configured with an optical encoder that facilitates improved measurement capabilities. The optical encoder may be configured in one of several different optical configurations to process differential signaling generated by light generating and detecting elements in the sensor.

### BACKGROUND OF THE INVENTION

This disclosure relates generally to measuring devices and methods.

It is known in the prior art to augment a conventional tape measure device with measuring and processing components that enable greater accuracy to the measurements made by the device. One such example is described and depicted in U.S. Pat. No. 11,460,284, the disclosure of which is hereby incorporated by reference. In a representative embodiment, the device has a housing that supports a display on which measurements are rendered. To take a measurement, a tape measure is extended from the housing at a given distance of interest. The tape measure includes unit length markings. The device housing supports a positional encoder, a processor, and memory/storage that supports control software executed by the processor to control the device. In particular, the control software is configured to process positional information received from the positional encoder, compute a linear location of the measuring tape (its degree of extension from the housing, as measured by the unit length markings), and to generate one or more control signals to drive the display to render positional data.

Although the above-described device provides significant advantages, it is desirable to provide improvements and enhancements to such devices, especially with respect to the speed and accuracy of the measurements.

### SUMMARY OF THE INVENTION

This disclosure provides for a tape measure system with a compact differential optical encoder that provides robust, fast and highly-accurate measurements. A digital tape measure device that implements this subject matter comprises an optical encoder and target arrangement that may be configured in one of several different optical configurations to process differential signaling generated by light generating and detecting elements in the sensor.

The foregoing has outlined some of the more pertinent features of the subject matter. These features should be construed to be merely illustrative. Many other beneficial results can be attained by applying the disclosed subject matter in a different manner or by modifying the subject matter as will be described.

### BRIEF DESCRIPTION OF DRAWINGS

FIG. 1 depicts a representative digital tape measure;

FIG. 2 depicts an a representative control circuit that implements a differential optical encoding scheme according to this disclosure;

FIG. 3 depicts a first embodiment (a vertical configuration) of the optical encoder;

FIG. 4 depicts a second embodiment (a staggered vertical configuration) of the optical encoder;

FIG. 5 depicts a third embodiment (a horizontal configuration) of the optical encoder;

FIG. 6 depicts a fourth embodiment (a “C” configuration) of the optical encoder;

FIG. 7 depicts a fifth embodiment (a horizontal configuration for differential absolute encoding) of the optical encoder;

FIG. 8 depicts a sixth embodiment of the optical encoder that combines several of the configurations;

FIG. 9 depicts how a differential signal (180°) is formed using an optical encoder that includes several receivers; and

FIG. 10 depicts how a quadrature signal (90°) is formed using an optical encoder that includes pairs of receivers.

### DETAILED DESCRIPTION OF THE INVENTION

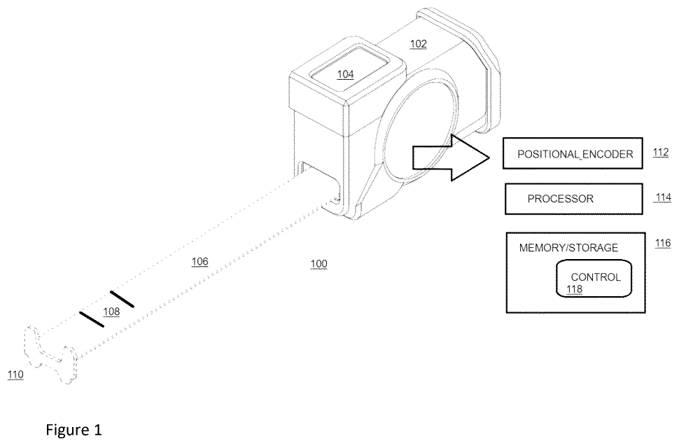

FIG. 1 depicts a typical digital tape measure device 100 in which the differential optical encoding techniques of this disclosure may be practiced. The device 100 is not intended to be limiting. In this exemplary embodiment, the device 100 has a housing 102 that supports a display 104 on which measurements are rendered. To take a measurement, a tape measure 106 is extended from the housing 102 at a given distance of interest. The tape measure 106 includes unit length markings 108, and terminates in a hook or similar end structure 110. The tape measure 106 extends from a reel (not shown) positioned within the housing. As further depicted, the housing also supports a positional encoder 112, a processor 114, and memory/storage 116 that supports control software 118 executed by the processor 114 to control the operations and functions of the device. The positional encoder may comprise an optical encoder. In general, the control software 118 executed by the processor 114 is configured to process positional information received from the positional encoder 112, compute a linear location of the measuring tape (in other words, its degree of extension from the housing, as measured by the unit length markings), and to generate one or more control signals to drive the display 104 and, in particular, to render positional data on the display. Given a tape measure that exhibits no fixed or scalar errors, the positional data (the measurement) rendered on the display exactly matches the unit length measurements indicated on the tape measure. In other words, the analog (physical) measurement corresponds precisely to the displayed digital measurement value.

Without intending to be limiting, a digital tape measure may be a device such as described in U.S. Pat. No. 11,460,284, the disclosure of which is hereby incorporated by reference. In that device, several encoding mechanisms are used to enable both absolute and incremental measurements to be taken.

According to this disclosure, a tape measure device such as depicted in FIG. 1 and described above includes an optomechanical element, namely, an optical encoder, which takes advantage of a “differential optical” signal. In general, and by way of further background, a differential signal works by placing at least two (2) sensing elements (e.g., elements A and A′) in a configuration in which one sensing element is sensing opposite effects with respect to the other sensing element, and vice versa. In other words, and by way of example, when sensor A senses a bright light, sensor A′ senses little to no light. At a high level, such configuration of the sensing elements means that any undesirable characteristics of the sensed signals, such as noise, signal drift, and the like, and that is common to both signals is canceled when subtracting the two signals from one another. This is the notion of “differential,” leaving the system with a clean signal that is translated into measurements and displayed on the device. Differential treatment of the signals (provided by elements A, A′) offers several benefits. In particular, the signal A (to take one of the two) does not need to be compared to a fixed reference point (to determine its value), as it can be compared against its counterpart signal A′. This eliminates the need to set a threshold value either in software or in hardware. Additionally, the combined signal (A+A′) is robust to changes in brightness of the light source, as such sources often vary in brightness as a function of their lifetime or operating environment. Further, the signaling is also robust to changes in reflectivity of the target, which also can over time or due to wear. Finally, the combined signal (A+A′) has increased amplitude, which results in higher signal strength and thus improved signal discrimination and processing speed.

According to this disclosure, a tape measure device is configured with a sensing system that employs optomechanical elements (e.g., an optical encoder) that leverages a differential signaling scheme such as described above. As will be seen, a representative optical encoder comprises a sensor element that supports at least one light emitting source (e.g., an LED or the like), and two or more light sensing elements (e.g., photodiodes, phototransistors, CCDs, or the like) in one of several possible configurations. The light generated by the light emitting source may be visible or non-visible. From an optomechanical standpoint, the sensor element works in association with a movable target that includes alternating dark and bright portions. In one example embodiment, the movable target comprises black and white stripes, but this is not a limitation, as the alternating stripes (portions) may differ in other ways (e.g., hue, saturation, contrast, and the like). Depending on the nature of the optical sensor (as described in more detail below), the target may have one or more rows (of bright and dark columns), and in some cases the configurations of those columns may also be varied. Generalizing, and for the purposes of the disclosure, the light emitting source is an “emitter,” and the light sensing elements comprise a “receiver. ” The combination of the emitter and the receiver are sometimes referred to herein as an “optical sensor. ” The movable target having the alternating dark or bright portions (collectively, a “pattern”) is sometimes referred to herein as a “target. ” In this implementation, the target is printed on and thus carried by the tape measure blade. The combination of the optical sensor and the target comprises a “differential optical configuration.”

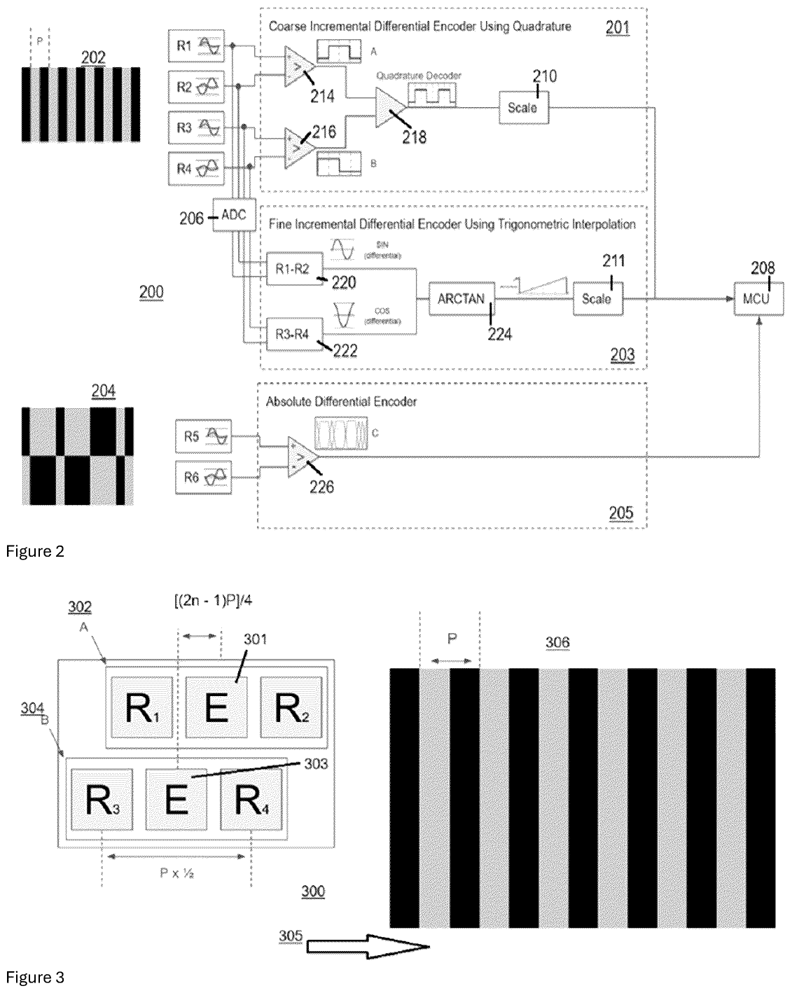

FIG. 2 depicts a control circuit 200 that implements a differential optical encoding scheme of this disclosure. In this embodiment, there are several encoding mechanisms depicted, one for incremental measurements, and the other for absolute measurements. Preferably, the mechanism for incremental measurements is applied against signaling derived from a first target 202 and comprises both a “coarse” incremental differential encoder (using quadrature) 201, and a “fine” incremental differential encoder (using trigonometric interpolation) 203. An absolute differential encoder 205 is applied against signaling derived from a second target 204 for absolute measurements. Although in the usual case both types of measurements are taken (and correlated to one another as described below), there is no requirement that both incremental and absolute measurements be taken (or that the incremental measurements include both coarse and fine readings). One or the other of the measurement mechanisms may be used, either alone or in combination, depending on the available targets and the actual implementation.

The reference “P” as depicted in the first target 202 corresponds to a pitch of the (depicted) pattern. In this example, the incremental encoding mechanism comprises four (4) receivers, namely, R1, R2, R3 and R4, and the signals generated by the receivers are shown by the accompanying waveforms. The control circuit 200 also includes an analog-to-digital converter (ADC) 206, a microcontroller unit (MCU) 208, and scaling functions 210 and 211. In this embodiment, the coarse quadrature module 201 comprises two (2) comparators 214 and 216 and one (1) quadrature decoder 218, preferably implemented in software. In this embodiment, the fine trigonometric interpolation module 203 comprises differentiators 220 and 222, and ARCTAN function 224.

Consistent with the discussion above concerning the differential signaling, a goal of the circuit is to generate two (2) sinusoidal waveforms that are 90°degrees out of phase (sine and cosine) with high signal robustness against disturbances the system might experience. These two waveforms are then analyzed in two distinct ways, namely, by quadrature and trigonometric interpolation provided by the respective modules 201 and 203. The quadrature module 201, which operates on digital bit signals (generated by the comparators 214 and 216, and the quadrature decoder 218) produces a scaled digital output (using scaling function 210) that can be interpreted by the MCU 208 very fast, but with only coarse resolution, e.g., approximately ¼^{th} the pitch (P) of the pattern. In contrast, the trigonometric interpolation module 203, which processes the differential signals (e.g., R1-R2, and R3-R4) has an analog output (generated by an inverse tangent (ARCTAN) function 224 and the scaling function 211) which is also interpreted by the MCU 208 through an ADC conversion, but not necessarily as fast as a digital one. The resolution, however, of the trigonometric interpolation module 203 is much higher than that of the quadrature module 201. Arranging the incremental measurement system as shown allows the optical sensor device to provide both fast but coarse and slow yet fine resolutions. Additionally, configuring the input signals (R1, R2) and (R3, R4) in differential pairs (180°out of phase) as depicted removes noise from each input signal, which ensures that the system is immune to changes that are observed by either receiver pair equally (also referred to as common-mode rejection).

As noted above, and when absolute encoding measurements are used, the absolute encoding mechanism 205 is operated in association with the incremental encoding mechanism described above. To this end, and in this embodiment, a representative target 204 is depicted on the bottom left. In this example, there are two (2) additional receivers, namely, R5 and R6, and the signals generated by the receivers are shown by the accompanying waveforms. The differential signal pair is processed using a comparator 226, and the output is fed to the MCU 208, which interprets the sequence read by the absolute encoder. When a complete sequence is read, and to facilitate error correction, the MCU 208 preferably associates a current relative incremental encoder location with a current absolute encoder location. Moreover, and consistent with the discussion above concerning differential signaling, configuring the input signals R5 and R6 in differential pairs (180°out of phase) as depicted removes noise from each input signal, which ensures that the system is immune to changes that are observed by either receiver pair equally (also referred to as common-mode noise rejection).

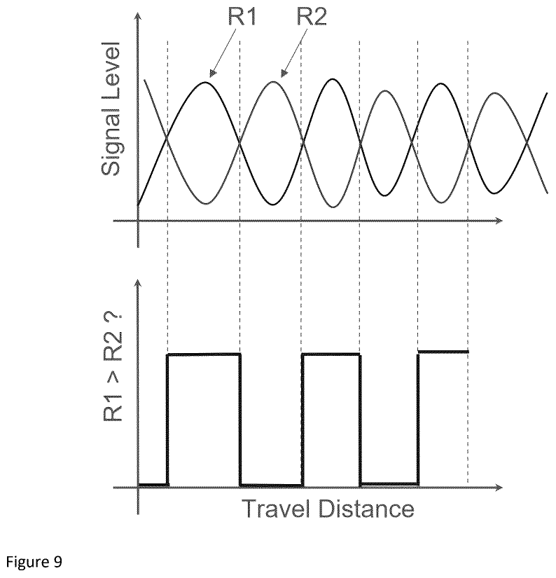

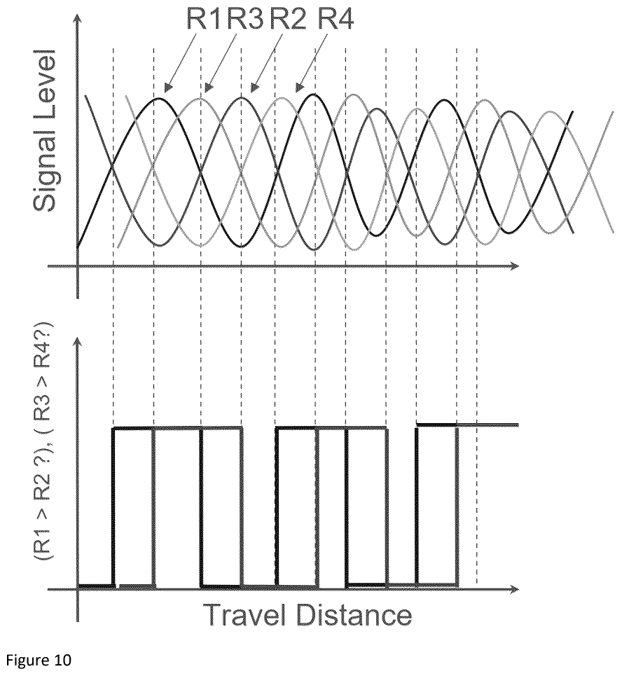

With the above as background, FIGS. 3-8 depict different embodiments, namely, ways that the emitters (light emitting elements) and the receivers (light receiving elements) can be arranged to meet the requirements for both the differential (180°) and the quadrature (90°) nature of the signaling. Further, FIG. 9 depicts how a differential signal is generated, given the signal levels at a pair of receivers (R1 and R2), and with respect to the travel distance of the target relative to the optical sensor that includes those receivers. FIG. 10 depicts how a quadrature signal is generated, given a set of receiver pairs (A: R1 and R2, and B: R3 and R4), once again with respect to the travel distance of the target relative to the optical sensor that includes those receivers. As depicted in FIG. 10, pair A (R1 and R2) and pair B (R3 and R4) are spaced by a multiple (n) of the pitch (P) plus (or minus) ¼ P to offset the signals by 90°.

According to a first embodiment of the optical encoder, FIG. 3 depicts a vertical configuration wherein the optical sensor 300 comprises emitters (E) 301 and 303, and two (2) pairs of receivers, namely, set A 302 (R1 and R2), and set B 304 (R3 and R4). In this differential optical configuration, the optical sensor 300 is oriented along a length axis 305 of the moving target 306. As depicted, the target 306 has a single row of alternating bright and dark portions (e.g. colors) along the length axis 305. The optical sensor is arranged as receiver-emitter-receiver (R-E-R), thus illuminating the target 306 along the length axis. In this configuration, and as depicted the receivers (R-E-R) are spaced by half-pitch (P×½) for the differential 180°signal; for the quadrature 90°signal, and consistent with FIG. 10, pairs A and B are spaced (relative to each other) by a multiple (n) of the pitch (P) plus (or minus) ¼ P to offset the signals by 90 degrees. The vertical configuration depicted here has an advantage that it only requires one (1) row of the alternating dark and light portions of the pattern. This configuration, however, is sensitive to the relative distance of the optical sensor from the target, as this varies the effective area of target illumination.

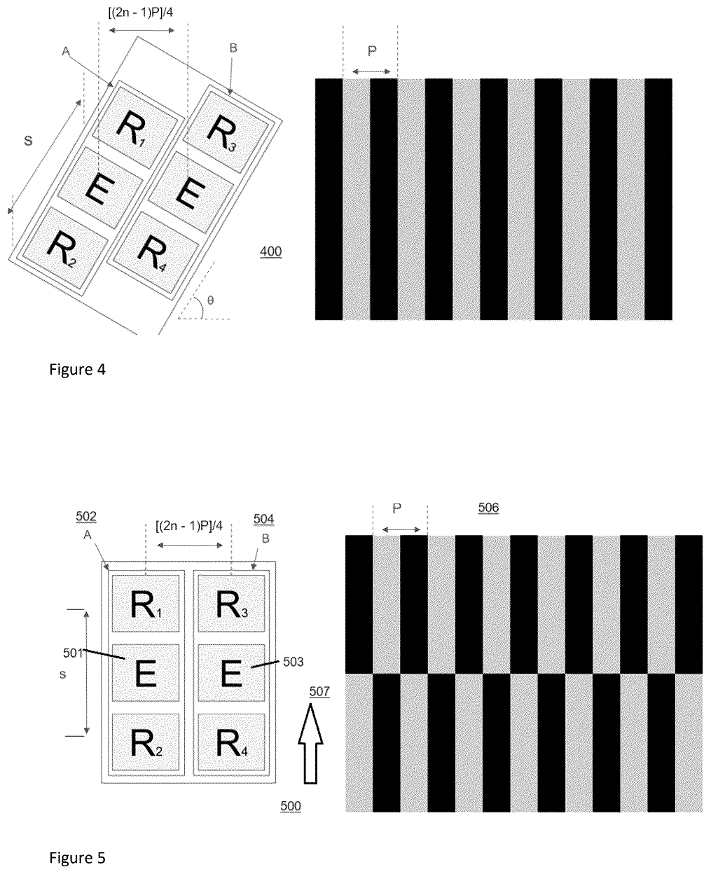

According to a second embodiment, FIG. 4 depicts a variant of the vertical configuration and that provides an improved operation, namely, a vertical-staggered configuration. While this optical sensor 400 includes the same emitter and receiver elements as depicted in FIG. 3, the orientation of the sensor is adjusted by a drift angle θ.

Accordingly, in this embodiment, the minimum receiver spacing (e.g., due to mechanical constraints) is lowered by introducing the drift angle (θ). In this embodiment, and for the differential (180°) signal, preferably the spacing S=(Pitch×½)/cos(θ), and therefore S>Pitch×½ for angles between 0 and 90 deg. For the quadrature (90°) signal, and once again as depicted in FIG. 10, pairs A and B are spaced by a multiple of the pitch (n) plus (or minus) ¼ P to offset the signals by 90 degrees.

According to a third embodiment, FIG. 5 depicts a horizontal differential optical configuration. In this embodiment, optical sensor 500 comprises emitters (E) 501 and 503, and two (2) pairs of receivers, namely, set A 502 (R1 and R2), and set B 504 (R3 and R4). In this embodiment emitter 501 is associated with set A, and emitter 503 is associated with set B. As depicted, the groups of elements (R1-E-R2) and (R3-E-R4) are positioned side-by-side, namely, along a width axis 507. In this embodiment, the target 506 has two (2) rows of alternating bright and dark portions along the length axis 505. In this arrangement, the optical sensor is arranged to illuminate the target 506 along the width axis 507. This configuration has certain advantages in that it is very tolerant to the distance of the sensor against the target, as the illumination of the pattern occurs along the width of the pattern, which prevents the light from bleeding the adjacent pattern columns. This configuration also has an advantage that it can be used as either an incremental or absolute encoder, as the target pattern does not need to be periodic, thereby allowing data to be encoded in it. As depicted in FIG. 5, and with respect to the differential (180°) signal, an emitter-receiver spacing(S) is no longer bound by the pitch (P), as the pattern itself is split and offset by 180°degrees, thereby offering greater flexibility in sizing(S). For the quadrature (90°) signal, once again pairs A and B are spaced by a multiple (n) of the pitch (P) plus (or minus) ¼ P to offset the signals by 90 degrees.

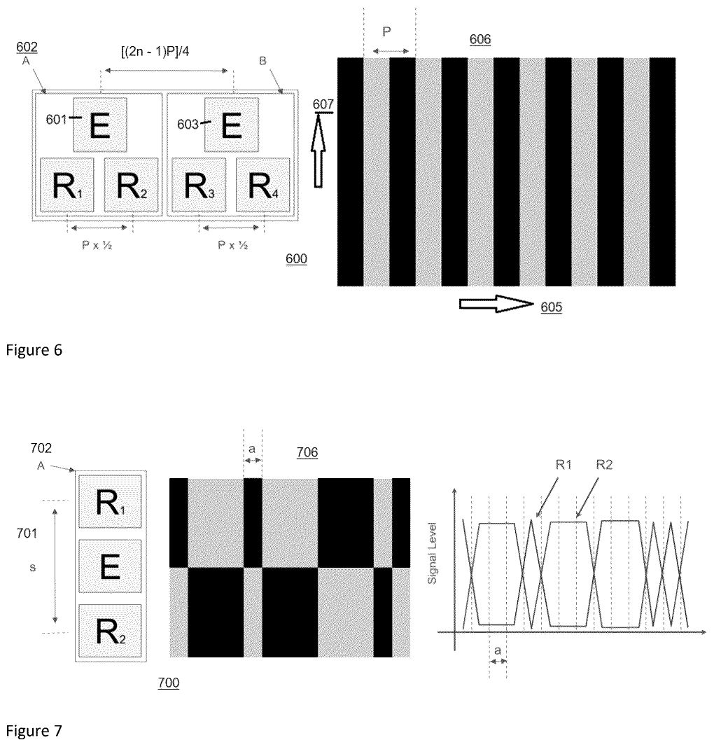

A fourth embodiment is depicted in FIG. 6. This version of the optical sensor 600 and the target is referred to as a “C” configuration due to the orientation of the emitter and its associated receivers in each element grouping. In this sense, the “C” configuration may be considered to be a combination of the vertical and horizontal configurations. In particular, here set A includes receivers R1 and R2 (602) as before, but with emitter E 601 positioned above and between the receivers. Set B includes receivers R3 and R4 (604), and with emitter E 603 likewise positioned. The groupings (R1-E-R2) and (R3-E-R4) are once again side-by-side. In this embodiment, the optical sensor 600 is oriented along the width axis 607 of the moving target 606, which includes one row of alternating bright and dark portions along a length axis 605. By arranging the optical sensor as R-R with an E on top, the target is illuminated along its width axis, which is desirable. This configuration is useful as an incremental encoder given that the target pattern is periodic. As depicted in FIG. 6, and with respect to the differential signal, the receivers in each group are spaced by half-pitch (P×½); this spacing increases the available space for a given pitch and component size. For the quadrature (90°) signal, once again pairs A and B are spaced by a multiple (n) of the pitch (P) plus (or minus) ¼ P to offset the signals by 90 degrees.

FIG. 7 depicts another embodiment, namely, where a horizontal configuration is used for differential absolute encoding. In this embodiment, the sensor 700 comprises a single group of elements, namely, emitter 701 and set A of receivers 702 (R1 and R2), configured as in FIG. 5, and a target 706 that has two (2) rows of alternating bright and dark portions. In this embodiment, and as depicted, the width of those portions is not uniform, and this facilitates the absolute encoding measurements. FIG. 7 in particular depicts the signal levels for the receivers R1 and R2, and how the spacing “a” in the pattern is reflected in the signaling. For the differential signal, this configuration of the receivers is useful to decode signals that are non-periodic while maintaining all the benefits of a differential system. This is particularly useful for an absolute encoding pattern, such as set forth on the target 706.

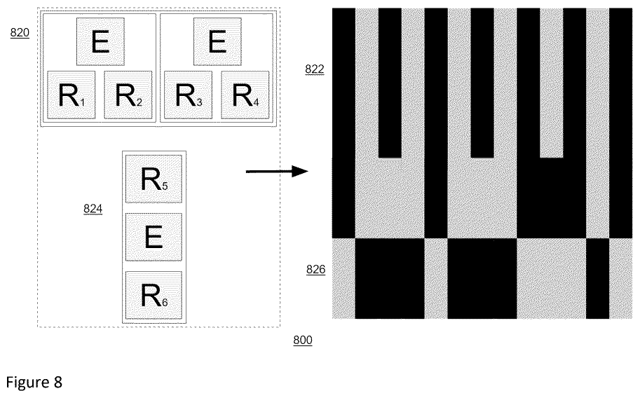

The configurations such as described above in FIGS. 3-7 may be combined (mixed and matched) to achieve further variant optical sensor configurations. For example, FIG. 8 depicts an optical sensor 800 that is a combination of a “C” configuration representative combination of a “C” configuration 820 (such as described above in FIG. 6), and a horizontal configuration 824 (such as described in FIG. 5). The respective targets 822 and 826 for each of the configurations are also depicted, and these targets may be combined into a single integrated target. In this example combination, which is not intended to be limited, the “C” configuration provides the incremental encoding, and the horizontal configuration provides the absolute encoding. In this example, the configurations are associated with one another by being placed one on top of the other. The combination shown in this figure is not intended to be limiting, as the various sensor configurations described above may be combined in many different ways.

As previously mentioned, further details regarding the digital measure device in which the techniques herein are practiced may be found in U.S. Pat. No. 11,460,284. The device may also be controlled, e.g., over-the-air, or directly via wired connection, by an external tool or device. Also, measurements may be transmitted, either over-the-air, or over that direct connection, to some external device or system, such as a smart phone, smart watch, other computing device, or other “smart”work tool.

The described control functionality may be practiced, typically in software, on one or more hardware processors, in firmware, or via other controllers. Generalizing, a microcontroller typically comprises commodity hardware and software, storage (e.g., disks, disk arrays, and the like) and memory (RAM, ROM, and the like), network interfaces and software to connect the machine to a network in the usual manner, and the like.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic. While given components of the system have been described separately, one of ordinary skill will appreciate that some of the functions may be combined or shared in given instructions, program sequences, code portions, and the like.

While in the typical arrangement the target of the differential optical configuration moves relative to an optical sensor that is fixed, the opposite arrangement, wherein the target is fixed and the optical sensor moves, may be implemented. Further, it should be appreciated that while relative movement of the target and the sensor is necessary to determine an absolute position of the tape measure, it is not necessarily always required for detecting incremental positions, as the sensor arrangement can be configured to provide a predictable reading instantaneously even if the tape is not moving. To this end, an incremental position identified from such a reading can be correlated (e.g., using a look-up table or other data structure) to a known distance within a given measurement range.

Having described the subject matter herein, what we now claim is set forth below.

1. A method operative in association with a measuring tape device, comprising:
configuring an optical sensor and a target in a differential optical configuration, the optical sensor comprising an emitter, and at least first and second receivers, the emitter and the first and second receivers configured with respect to one another in a grouping, and wherein the target comprises one or more patterns, and wherein a pattern comprises a set of alternating bright and dark portions;
moving the target relative to the optical sensor;
as the target is moved relative to the optical sensor, capturing signaling from the first and second receivers; and
processing the signaling to identify an extent of movement.

2. The method as described in claim 1, wherein the target is associated with a tape measure and moves relative to the optical sensor.

3. The method as described in claim 2, wherein the extent of movement is a measurement associated with a position of the tape measure relative to a housing of the measuring tape device.

4. The method as described in claim 1, wherein the optical sensor has a length axis, and a width axis.

5. The method as described in claim 4, wherein the grouping is at least one row that comprises the first receiver, the emitter, and the second receiver, the pattern is a single row along the length axis, and the emitter illuminates the target along the length axis.

6. The method as described in claim 4, wherein the grouping is at least one row offset from the length axis by an angle Θ and that comprises the first receiver, the emitter, and the second receiver, the pattern is a single row along the length axis, and the emitter illuminates the target along a path comprising the length axis times the angle Θ.

7. The method as described in claim 4, wherein the grouping is at least one column that comprises the first receiver, the emitter, and the second receiver, the pattern includes first and second rows along the length axis, and the emitter illuminates the target along the width axis.

8. The method as described in claim 4, wherein the grouping comprises the first receiver spaced from the second receiver and with the emitter therebetween and offset along the width axis, the pattern is a single row along the length axis, and the emitter illuminates the target along both the length axis and the width axis.

9. A measurement system, comprising:
a housing;
a reel that supports a tape measure configured for extension from the housing to a measurement location;
an optical sensor comprising at least one emitter, and at least first and second receivers, the emitter and the first and second receivers configured with respect to one another in a grouping;
a target comprises one or more patterns, and wherein a pattern comprises a set of alternating bright and dark portions, wherein the target is associated with the tape measure; and
a control circuit configured to receive and process differential signaling generated by the optical sensor to determine an extent to which the tape measure has been extended from the housing.

10. The measurement system as described in claim 9, further including a display, the control circuit providing a control signal to control the display to provide an indication of the extent.

11. The measurement system as described in claim 9, wherein relative to the target, the optical sensor is configured in one or more differential optical configurations.

12. The measurement system as described in claim 11, wherein the one or more differential optical configurations include: a vertical configuration, a staggered vertical configuration, a horizontal configuration, a “C” configuration, and combinations thereof.

13. The measurement system as described in claim 9, wherein the control circuit outputs one of: a coarse measurement, a fine-grained measurement, and combinations thereof.

14. The measurement system as described in claim 9, wherein the optical sensor and the control circuit comprise one of: an absolute encoder, an incremental encoder, and combinations thereof.

15. The measurement system as described in claim 9, wherein the control circuit is responsive to movement of the target to the measurement location.
